(19) United States
(12) Patent Application Publication
(10) Pub. No.: US 2005/0024492 A1
(43) Pub. Date: Feb. 3, 2005

(54) Obstacle detection and terrain classification method

(76) Inventors: Christoph Schaefer, Friedrichshafen (DE); Stefan Baten, Meckenbeuren-Brochenzell (DE); Werner Berger, Stetten (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/882,668

(22) Filed: Jul. 2, 2004

(30) Foreign Application Priority Data
Jul. 3, 2003 (DE) 103 30 011.2

(51) Int. Cl. G05D 1/00

(52) U.S. Cl. 348/135; 701/28

(57) ABSTRACT

In a method of obstacle detection and terrain classification for off-road vehicles, a range image of the terrain within a scene is generated by scanning the scene using, for example, a range-imaging sensor. The sensor data are then transformed into a three-dimensional surface which is composed of individual finite elements and which models the scene that has been scanned by the sensor; and the three-dimensional surface is provided to yield a Terrain Elevation Function which is defined in a terrestrial coordinate system. (The Terrain Elevation Function is extended continuously where it is undefined.) A Confidence Function is generated for the Terrain Elevation Function defined in the same coordinate system as the Terrain Elevation Function, the Confidence Function representing a measure of confidence in the Terrain Elevation Function and depending on the distance of a value of the Terrain Elevation Function from a sensor measurement point. A Floor Function is then generated by smoothing the Terrain Elevation Function, which is used in turn to generate a Terrain Classification Function, by evaluating the slope of the Terrain Elevation Function, by comparing it with the Floor Function, and evaluating the Confidence Function. The terrain is classified with respect to its vehicular accessibility, using the Terrain Classification Function.

This application claims the priority of German patent document 103 30 011.2, filed 3 Jul. 2003, the disclosure of which is expressly incorporated by reference herein.

The invention relates to a method of obstacle detection and terrain classification for off-road vehicles, especially autonomous, unmanned off-road vehicles. More specifically, the invention provides a robust method for classifying terrain accessibility and for identifying obstacles and terrain which can be driven on.

The method according to the invention utilizes the following steps:
generating a range image of the terrain by means of a range-imaging sensor;
transforming the sensor data into a three-dimensional surface which is composed of individual finite elements and which models the scene scanned by the sensor;
projecting the three-dimensional surface to yield a Terrain Elevation Function which is defined in a terrestrial coordinate system;
extending the Terrain Elevation Function continuously where it is undefined;
a generating a Confidence Function for the Terrain Elevation Function defined in the same coordinate system as the Terrain Elevation Function, the Confidence Function representing a measure of confidence in the Terrain Elevation Function, and depending on the distance of a value of the Terrain Elevation Function from a sensor measurement point;
generating a Floor Function by smoothing the Terrain Elevation Function;
generating a Terrain Classification Function by evaluating the slope of the Terrain Elevation Function, comparing the Terrain Elevation Function with the Floor Function, and evaluating the Confidence Function; and
classifying the terrain with respect to its vehicular accessibility using the Terrain Classification Function.

Such classification can be represented using a so-called Map of Obstacles (MO) consisting of color codes for various classes of terrain (e.g. accessible terrain, negative obstacles (indentations), positive obstacles).

Based on the information contained in the generated Map of Obstacles, the method according to the invention can be supplemented by searching for and finding a route to bridge ditches which are present in the terrain, by means of the following steps:
filtering the Terrain Classification Function using templates for ditches of various widths and orientations, in accordance with the method of Matched Filtering, to detect the course of a ditch or of its edge; and
searching for potential routes along which to bridge the ditch, starting from points determined to lie on the edge of the ditch and proceeding orthogonally with respect to that edge, and validating a route using the Terrain Elevation Function, the Floor Function, and the Confidence Function.

The code forming the Maps of Obstacles, which has been produced using the invented method, may be passed on to an on-board computer of a vehicle which performs autonomous navigation (that is, in particular, obstacle avoidance and ditch crossing), and which is equipped with an interface with vehicle control.

The method according to the invention is amenable to real-time implementation.

A system capable of executing the invented method comprises a range image sensor, a real-time data processor and optionally, a navigation system for sensor data acquisition.

Range Imaging Sensor

The preferred choice for the range imaging sensor (Range Image Camera RIC) is a scanning laser radar, as described, for example, in German patent documents DE 39 42 770 C2 and DE 43 20 485 A1. A typical RIC suiting the task of ditch detection will generate 4 range images per second with the following characteristics:
size: 64×128 (vertically×horizontally)
field of view: 30°×60° (vertically×horizontally)
angular resolution: about 0.5° in either direction
measurement range: about 50 meters
measurement resolution in range: 3 cm

The RIC is mounted on the vehicle in a forward-looking position and serves as data source for the real-time data processor.

Real-Time Data Processor

The real-time data processor may be a commercially available microprocessor and advantageously should provide a processing power of around 1 GFLOPS. The above-mentioned Maps of Obstacles are the output of the real-time data processor, represented as data words (codes) on the nodes of a discrete, horizontal grid.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an off-road scene from the perspective of the sensor;

FIG. 2 is a range image of the scene of FIG. 1, generated by the RIC;

FIG. 3 is a “color-coded” Map of Obstacles which has been generated according to the invented method from the range image of FIG. 2, with the RIC placed at the center of the lower edge of the image and looking in the direction of the arrow;

FIG. 4 illustrates a Finite Element (FE): every triple of pixels in the range image defines such a triangular element in three-space;

FIG. 5 shows the Terrain Classification Function where a positive obstacle occurring in the Terrain Elevation Function G is cut off by the Floor Function A;

FIG. 6 shows the Terrain Classification Function where a step occurring in the Terrain Elevation Function G by means of the Floor Function A is interpreted as a ditch on one side and as positive obstacle on the other;

FIG. 7 shows a Confidence Function T as an example of an implementation of the function p(λ;λ₀,Δλ);

FIG. 8 illustrates the detection of ditch edges using Matched Filtering: definition of ditch template with defined orientation.

### DETAILED DESCRIPTION OF THE DRAWINGS

In what follows, the generation of the Map of Obstacles is described. As has been said, the MO-codes are used by a subsequent functional module to navigate the vehicle in the portion of terrain which has been scanned by the sensor. The MO generation proceeds in the following steps:
1. generating a range image;
2. transforming data sets;
3. calculating the Terrain Classification Function;
4. searching for routes to bridge ditches.
   Generating a Range Image

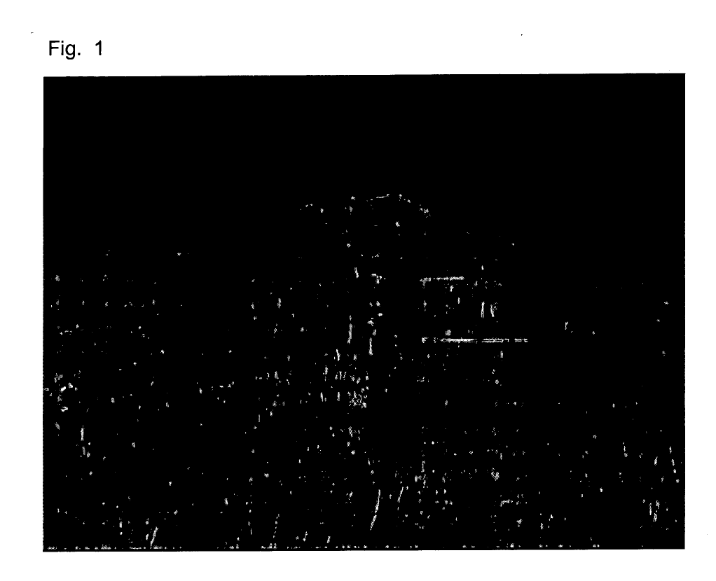

FIG. 1 shows an original scene (from the perspective of the sensor), in which the corresponding terrain is to be classified with respect to its accessibility by the vehicle, using the invented method. A trench with nearly vertical walls is visible stretching out in sensor-looking direction. Its width at the far end is about twice that at the near end. At the far end of the trench, behind it a positive obstacle consisting of a pile of soil is visible. The background of the image is completely formed by pine trees in close formation.

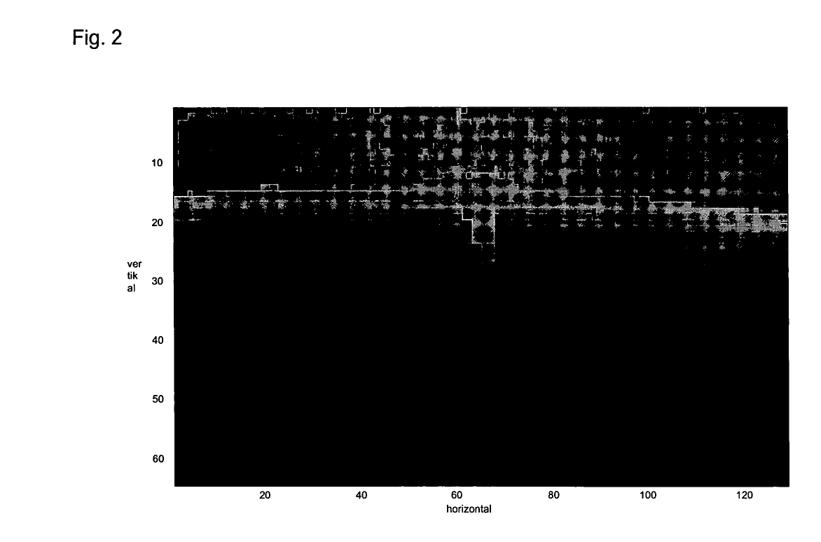

FIG. 2 shows a range image corresponding to the original scene of FIG. 1, taken with a RIC. A range image is a matrix of pixels whereby the color or gray scale which is attributed to each pixel corresponds to the distance of the respective scene point from the sensor rather than to local scene reflectivity—as is the case for a conventional optical image of the scene. In the range image shown in FIG. 2, the distance of a scene point grows as the pixel gray shade becomes lighter.

Data Transforms

The data transforms map RIC-data from their original format representing a range image to functions of the type z=ƒ(x,y) defined in a terrestrial, Cartesian coordinate system. The z-axis in this system points in vertical direction. All implemented functions are discrete; i.e., they are defined only on the nodes Kₖₗ=(xₖ,yₗ) of the grid:
zₖₗ=ƒ(xₖ,yₗ)

The data transforms by themselves do not produce any detection or classification information and proceed as described in the following.

Input of Raw Range Image Data.

The raw data from the RIC are input framewise, decoded, and transformed to give actual range values. Invalid values (i.e., values corresponding to insufficient signal strength of the echo or values where the admitted measurement range gate of the RIC has been exceeded from below or above) will be detected by a sensor of favorable choice and coded accordingly. The corresponding range image pixels are then coded as being invalid.

Interpolation of Range Image.

For physical reasons (eg., specular reflection by illuminated objects or exceeding of measurement range) invalid pixels cannot be avoided; and later, in the MO, they produce undesirable “holes” (white areas). Various methods of interpolation can be used to assign values to invalid pixels. For example, invalid pixels possessing at least two valid neighbors (on both sides) in either vertical, horizontal, or diagonal directions, may be replaced by the average value of one of these pairs. This interpolation is applied to the complete frame three times in sequence and improves the obtained results substantially.

Coordinate Transform.

The scalar range image obtained in this way is now transformed to give a matrix of 3-d vectors. This is executed in two steps: taking into account the scan geometry of the sensor, all valid measurements are represented as 3-d vectors in the (Cartesian) coordinate system of the sensor (pointing to the corresponding position of reflection). In the second step, these vectors are transformed to produce their terrestrial coordinates, taking into account the current sensor position and attitude.

Input of Sensor State Data.

In the instance of highly dynamic vehicle motion, an accurate computation of these terrestrial coordinates requires dynamic input of position and attitude data of the sensor, provided by a vehicle navigation system with synchronous interface with the real-time data processor. These state data enter the above mentioned transform. For moderately dynamic vehicle motion, they are dispensable in the presence of a RIC frame rate of at least 4 Hz.

Scene Modelling by Finite Element surface.

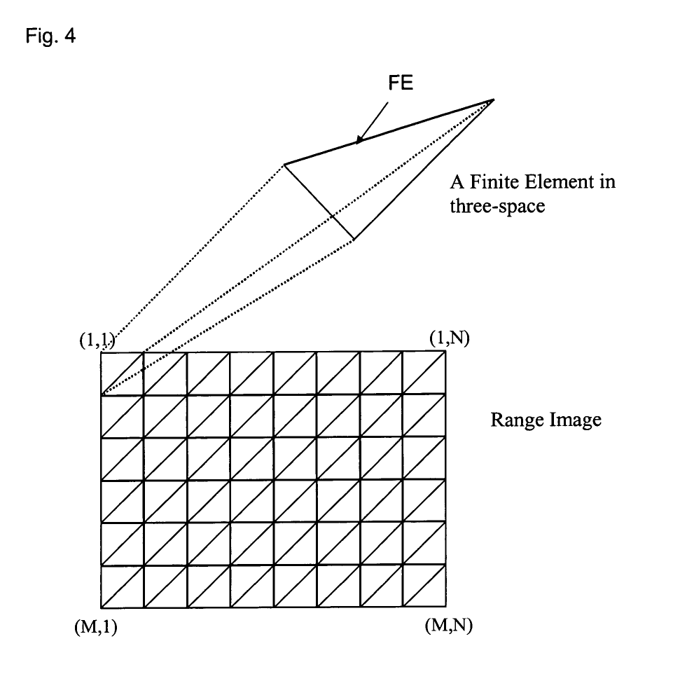

In order to avoid obtaining merely an unstructured three-dimensional cluster of points but instead a three-dimensional surface representation of the scanned scene, one Finite Element (FE) is generated from every set of three adjacent pixels,(as shown in FIG. 4). More precisely, the three vectors corresponding to every triangle of pixels in the image plane, will define the three corners of a triangle in three-space. By partitioning the range image into triangles of adjacent pixels as shown, a connected surface which models the scanned scene is obtained.

Pixels in the range image which are invalid are ignored. (That is, all FE for which this pixel would have provided a corner, are not generated.) Hence the modelled surface may contain holes.

Every FE which does not occur in perfectly vertical orientation, may be represented by a linear function
z=aᵢ+bᵢ·x+cᵢ·y
where the three coefficients aᵢ,bᵢ,cᵢ are particular to the i-th FE and may be calculated from the coordinates of the three corner vectors. The domain of definition for this function is, of course, limited to the vertical projection of the FE onto the x,y-plane, and is triangular in shape.

Calculation of Terrain Elevation Function.

The need to produce the FE surface just described results from the desire to generate a Terrain Elevation Function
z=G(x,y)
which is represented in the terrestrial coordinate system (with vertical z-axis) and which will be useful in the subsequent processing steps. For the numerical representation of the Terrain Elevation Function, a periodic grid with quadratic meshes and rectangular domain is defined in the x,y-plane. The mesh width (ie., the cell size in the MO) is parametrizable. Vertically above each node will be found either just one FE (typical terrain) or several FE (complex scene, e.g. forest) or no FE at all (invalid pixel in the range image or node outside of the sensor field of view). In the first case, to define G at a node (xₖ,yₗ), the z-value of that FE is used (with index i) whose domain of definition contains that node:
G(xₖ,yₗ)=aᵢ+bᵢ·xₖ+cᵢ·yₗ

In the second case, the maximum is taken of the z-values (evaluated at this node) for all FE into whose respective domains of definition the node falls. In the third case, no value is presently given to the Terrain Elevation Function at this node; a replacement value is later inserted in order to be able to process the function. (See Approximation and Extension of G by Means of a Tilted Plane, hereinafter.)

By means of the Terrain Elevation Function a projection of the sensor data into a unique, discrete function has been achieved which is defined in the terrestrial coordinate system and on a regular grid. This function is better amenable to subsequent processing than the original unstructured cluster of points. In complex scenes (with non-unique z=z(x,y) representation of the FE surface) G will describe an “envelope from above”.

Computation of Confidence Function.

The z-values of the G -function are not all equally credible as physically true values. For example, due to shading effects, lengthy Finite Elements will occur behind the closer of the two walls of a trench with transversal orientation. In the subsequent calculation of G this will lead to a significant number of function values which are distant from actual measurement values and which therefore do not correctly represent the true shape of the terrain.

For this reason, the so-called Confidence Function
z=T(x,y)

is introduced, which is defined on the same rectangular, uniform x,y-grid as G. With a value between 1 and 0, T indicates whether the corresponding value of G is located closer to or farther from an actual RIC-measurement and hence whether it is more or less reliable. The distance metric employed in this context takes into account the horizontal density of measurement points as it would occur on perfectly horizontal grounds. This means that in the far field of the MO larger horizontal distances to actual measurement points are accepted than in its near field, without reduction of confidence. In the presence of discontinuities in the range image (e.g., at the first edge of a transversally oriented trench), the confidence in the values of G rapidly drops to 0 since once in the trench, the horizontal distance to the closest actual measurement (sitting on the edge) quickly increases. There exist various possibilites of constructing Confidence Functions. One example is furnished in the Examples of Instantiation below.

The Confidence Function is an adequate method of detecting transversally oriented trenches even at large distances, and for this reason has shown to be indispensable. In the MO, areas of little confidence are attributed their own color code (in the present example white). As the trench is approached, these areas become smaller because the floor of the trench becomes visible to the sensor.

After having generated the G- and T -functions from the range image data, the data transforms are complete. The following, second step is the computation of the discrete Terrain Classification Function λ=Z(x,y) which is defined on the nodes of the grid of the MO just as G and T. In this context, λ represents the desired MO-code value which classifies the terrain at the respective node as lying on a ditch, being an accessible point, etc.

Computation of Terrain Classification Function

The classification of the terrain, i.e., the computation of Z(x,y), is achieved by applying the following methods:
1. by analyzing the slope of G(x,y) (following some smoothing in order to eliminate local signal noise)
2. by comparing the Terrain Elevation Function G(x,y) with a Floor Function A(x,y).

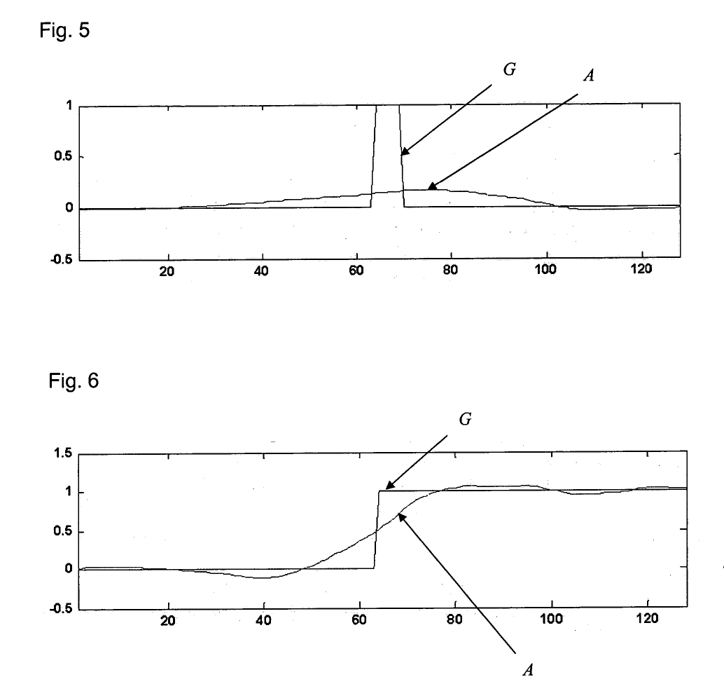

The Floor Function essentially traces the ground, cutting off positive, isolated obstacles such as posts, rocks, trees etc. (cf. FIG. 5) and spreads over negative obstacles such as ditches and holes. Comparing G(x,y) with A(x,y) allows to detect positive and negative obstacles:
G(x,y)<A(x,y)−h₁ : negative obstacle is present at location (x,y)
G(x,y)>A(x,y)+h₂ : positive obstacle is present at location (x,y)
h₁>0 and h₂>0 are small, positive thresholds which serve to suppress small deviations between G(x,y) and A(x,y).

Mathematically, the Floor Function is obtained by smoothing the Terrain Elevation Function. The developed smoothing procedure in a preferred implementation has two steps, and is described below.

Any method of terrain classification must be able to handle three basic types of obstacles: positive obstacles, negative obstacles, and step-obstacles. The detection of positive and negative obstacles is achieved by comparison of G(x,y) with A(x,y), as already outlined. In the instance of terrain steps (cf. FIG. 6) the comparison of G(x,y) with A(x,y) leads to the detection of a positive obstacle on one side of the step and the detection of a ditch on the other. Despite the detected ditch being virtual, in this way, terrain steps are robustly warned of by this method, particularly since such ditches later cannot be classified as bridgable (see Bridging of Ditch). A robust terrain step detection is additionally provided by the large absolute value of slope of G(x,y) at the precise location of the step.

If the ditch is very wide, A(x,y) will not stretch over it but will touch the floor of the ditch at least at its center. In this case, the ditch is no further interpreted as a single, connected obstacle but as a sequence of two obstacles representing two terrain steps: a down step and an up step. In this way, the floor of the ditch in principle can be classified as accessible. This is in fact desirable, for example in the case of a dry river bed.

In what follows, the individual steps required to compute the Terrain Classification Function Z(x,y) will be defined.

Bounding of G from Above and Below.

z-values of G which deviate from the terrain elevation which is present at the footprint of the sensor, by more than t meters in either direction, up or down, are bounded in order to avoid excessive oscillations of the subsequent smoothing functions:

$${\tilde{G}}_{kl} = \{ \begin{matrix}t & if {G}_{kl} > t \\ {G}_{kl} & if - t \leq {G}_{kl} \leq t \\ - t & if {G}_{kl} < - t\end{matrix}$$

Approximation and Extension of G by Means of a Tilted Plane.

Due to the limited sensor field of view and/ or shading effects caused by objects in the scene, the portion of terrain imaged by a single frame will not completely fill the rectangular domain of definition in the x,y-plane which is required for processing, with data. Therefore a continuous extension of the available terrain data is required. In a preferred embodiment of the method, for each image a linear, two-dimensional plane P(x,y)=a·x+b·y+c is therefore inserted “optimally” into the scene which will approximate G in its domain of definition and will extend this function properly wherever it is not defined. The parameters a,b,c are computed once for every range image using a three-dimensional Hough Transform. In what follows, \tilde{G} represents the bounded Terrain Elevation Function, however extended as described such that \tilde{G} is now everywhere defined. In addition to this linear approach which represents a good compromise between accuracy and computing expense, other known methods of determining a continuous extension of G which is as smooth as possible, may be employed, using e.g. interpolation and extrapolation.

First Smoothing Step.

The Terrain Elevation Function \tilde{G} now is subjected to a first step of smoothing (e.g., by applying a two-dimensional, 4-level Discrete Wavelet Transform (DWT) to \tilde{G} in its rectangular domain of definition). This results in the generation of thirteen subbands. Of these, only the LL-band of the fourth level are used for the reconstruction of the transformed signal, while the signals of all the other bands are set to zero. The signal B reconstructed in this way represents the desired smoothing of the original signal \tilde{G}. B is defined on the same grid as \tilde{G}.

Practical applications show that near major positive obstacles, B is still contaminated by relatively strong oscillations (similar to the Gibbs-Ringing in Fourier Transform practice). Using B, major positive obstacles are thus preliminarily detected and deleted from \tilde{G}, leading to an improved representation A of the Floor Function in a subsequent, second smoothing step. This procedure is defined next.

Elimination of Large Positive Obstacles.

At locations where the Terrain Elevation Function \tilde{G} significantly exceeds the Floor Function B, an obstacle is present. A new Floor Function Ĝ, deprived of the large obstacles, is obtained by replacing the z-values of \tilde{G} at these locations by P:

$$\hat{G} ( x , y ) = \{ \begin{matrix}P ( x , y ) & where \tilde{G} ( x , y ) > B ( x , y ) + p \\ \tilde{G} ( x , y ) & otherwise\end{matrix}$$

Of course, in practice this definition only applies to positions which are discrete nodes (xₖ,yₗ)

Second Smoothing Step.

The Floor Function Ĝ obtained in this manner is now smoothed just as before \tilde{G}. This leads to a second Floor Function A which is better than B because it exhibits significantly reduced “ringing”. Using G and A the Terrain Classification Function Z is determined which serves to generate the color codes of the MO.

Computation of Terrain Classification Function.

The Terrain Classification Function λ=Z(x,y), which is defined on the same discrete grid as the functions G(x,y) and A(x,y) assumes different values which are coded into colors when the Map of Obstacles (MO), is generated on this grid.

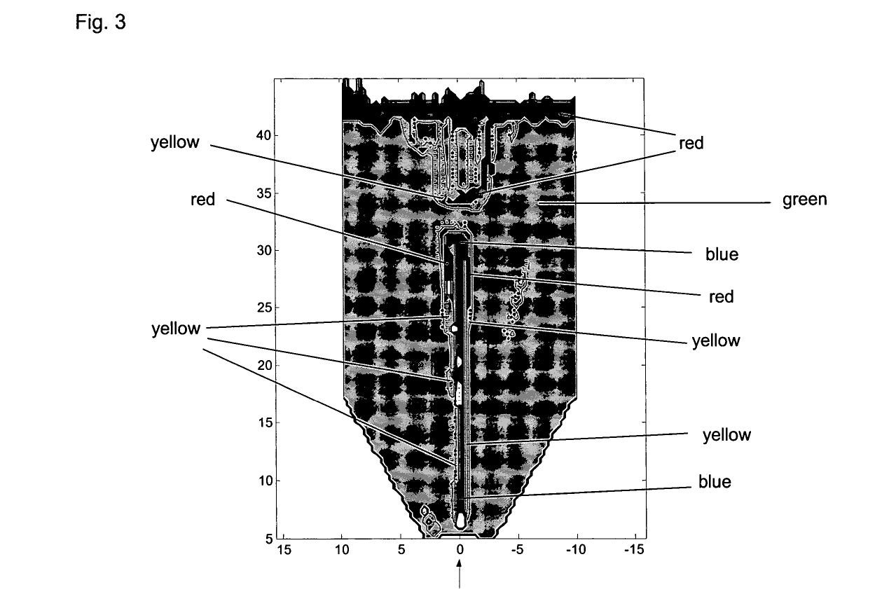

Z(x,y)=1 at nodes where there are positive obstacles which cannot be driven over. This value is assigned whenever the Terrain Elevation Function rises above the Floor Function by at least h₂ meters. These nodes are coded red in the MO (FIG. 3).

Z(x,y)=−1 at nodes where there is a ditch present which must either be avoided or crossed (see description below concerning the step “Bridging of Ditches”). This value is assigned whenever the Terrain Elevation Function drops below the Floor Function by more than a threshold h₁ depending on distance. These nodes are coded blue in the MO.

Z(x,y)=−2 at nodes where the original Terrain Elevation Function G is undefined or assumes a low value of confidence T(x,y) <0.5. These nodes are coded white in the MO.

The remaining nodes are assigned a value λ between 0 and 1 which is proportional to the absolute value of the gradient of the Terrain Elevation Function G:
λ(x,y)=min {c·|∇G(x,y)|;1}

A low (absolute) value of the gradient leads to coding the corresponding nodes green, signalling vehicle accessibility. A high value of the gradient may be due to either local roughness of the terrain or substantial global terrain slope. In either case, when a certain threshold of absolute value is exceeded, coding is yellow, and the normalized direction of the gradient is shown as a black arrow. Absolute values of the gradient exceeding a certain maximum lead to a value of 1 of the Terrain Classification Function, as do obstacles, and are also coded red, without arrows.

In the following table, the given MO-codes are summarized together with their interpretation. It should be clear that the indicated values for colors and values are just examples.

Map of Obstacle-Code

| | value | |
|---|---|---|
| color | λ = Z(xₖ, yₗ) | Significance for the coded nodes |
| white | −2 | node is invisible (e.g. behind an |
| | | obstacle or outside sensor field of view) |
| | | or possesses only a small confidence |
| | | value |
| blue | −1 | negative obstacle (=ditch) |
| blue with | (−0.99)-(−0.01) | ditch which can be crossed in the |
| red arrow | | direction of the arrow (or antiparallel to |
| | | it) |
| | | (A vehicle-dependent, maximum width |
| | | of a ditch which can be crossed is an |
| | | adjustable input parameter.) |
| green | 0-0.49 | accessible to vehicle |
| yellow with | 0.5-0.99 | terrain is accessible under restrictions: |
| black arrow | | vehicle may only drive in the direction |
| | | of the arrow (or antiparallel to it) |
| red | 1 | positive obstacle |

An example for an MO which has been coded in accordance with the disclosed invention for the original scene of FIG. 1 is shown in FIG. 3. The position of the sensor is at the center of the lower edge of the image, and the line of sight is horizontal and in the image runs from bottom to top.

Bridging of Ditches

After computing the Terrain Classification Function, all nodes of the MO which are associated with ditches have been detected. The bridging of ditches in the following step requires viewing ditches as objects, and ditch direction and width are to be determined.

Identification of Ditch Direction.

If potential “bridges” over ditches are to be found, elongated ditches which are not too wide need to be detected. The following procedure is conceivable: from the Terrain Classification Function there is derived a normalized “Ditch Signal”

$${W}_{0} ( x , y ) = \{ \begin{matrix}- 1 & if Z ( x , y ) = - 1 \\ 0 & otherwise\end{matrix}$$

which is then filtered using normalized ditch templates of various widths and orientations (method of “Matched Filtering”, see no. 2 of the instantiation examples below). If the filtered signal exceeds a certain threshold at some node, it is concluded that there is a ditch structure present which is similar to the template. The method is generally robust due to its integrating nature.

In working with real test data, however, the edges of the ditches defined by the condition Z(x,y)>−1 turn out to be unstable. This is due to the forward-looking sensor geometry and the imprecise detectability of the front edges of ditches which are oriented in transverse direction. On the other hand, the far edge of such a ditch usually shows well, leading to the method of using the “Ditch Edge Signal”

$${W}_{0} ( x , y ) = \{ \begin{matrix}- 1 & if Z ( x , y ) > \frac{1}{2} \\ 0 & otherwise\end{matrix}$$

to find lengthy and narrow ditch edges instead of the ditches themselves.

Ditch edges are searched for in four directions: parallel to the x-axis, along the diagonal in the x,y-plane, parallel to the y-axis, and along the anti-diagonal in the x,y-plane. This means that templates are used for of these directions. Additionally, in each direction several templates are used which correspond to edges of various widths.

Following the successful detection of an edge of a ditch and its orientation, starting from every single point on such an edge, a bridging of the ditch in a direction which is orthogonal to the ditch's orientation may be tried.

Bridging of Ditch.

Starting from every single node which, using the above method, has been associated with an edge of a ditch, the program steps through the x,y-grid in a direction which is orthogonal to the orientation of the ditch. In the course of this procedure, at every node the z-values of the Terrain Elevation Function G and the Floor Function A are compared. As long as G lies below A, stepping in the defined direction is continued; as soon as this condition is not satisfied, the bridging procedure is stopped. Starting from the initial node, this bridging procedure is conducted in both possible directions.

Bridging routes (“bridges”) whose length exceeds a maximum value which is specified by the user, are not admitted. The complete bridge is only validated if it contains at least one blue node or one node of low confidence, in order not to build bridges across slightly undulated terrain (which is considered accessible) but only across true ditches. (Bridging is terminated if a red node of the Terrain Classification Function is met or a node which is not defined for G, so as to avoid trying to build a bridge into an obstacle or out of the field of view.) The bridging routes determined in this fashion are coded as recommended bridges.

### EXAMPLE 1

### Construction of a Confidence Function

The Confidence Function z=T(x,y) is defined on the nodes of the MO-grid Kₖₗ=(xₖ,yₗ):
(*) Tₖₗ=T(xₖ,yₗ)

The Confidence Function assumes values
0≦Tₖₗ≦1

The value 1 implies full confidence, the value 0 no confidence in the corresponding value of Gₖₗ=G(xₖ,yₗ).

In what follows, a continuously defined Confidence Function z=T(x,y) is constructed from which the desired discrete Confidence Function can be obtained by evaluation in accordance with (*).

For i=1, . . . , I let Pᵢ=(xᵢ,yᵢ,zᵢ) denote measurement vectors in terrestrial coordinates (for clarity using a single index). In a first step, for each measurement point Pᵢ an individual Confidence Function z=Tᵢ(x,y) is defined. The Confidence Function is later obtained from the individual Confidence Functions by maximization. We begin with the construction of an individual Confidence Function.

In close proximity to the measurement components xᵢ,yᵢ the confidence is high (→1) but drops (→0) with increasing distance to it. “Proximity” in this context is scaled depending on the resolution of the sensor. We therefore begin by determining the resolution of a sensor on flat terrain.

We shall assume that the scan mechanism of the sensor possesses a vertical and a horizontal axis such that the directions of scan can be expressed in terms of an azimuth angle φ and an elevation angle θ, as for polar coordinates. The scan directions of the sensor (of height H) which correspond to the pixels of the range image, when they intersect with an ideally flat ground plane z=0, define the nodes of a curvilinear grid whose grid lines are the coordinate lines of planar polar coordinates. (These are concentric circles about the origin on one hand, and radial lines intersecting at the origin on the other.) Let ρ, φ define such polar coordinates in the x,y-plane:
x=ρ cos φ
y=ρ sin φ
and inversely, for x>0

$$ρ = \sqrt{{x}^{2} + {y}^{2}}$$

$$φ = arctan ( \frac{y}{x} )$$

The radial resolution of the curvilinear grid on the ground (i.e. the radial distance from one node to the next) is approximated by the formula

$$Δ ρ ( x , y ) \approx Δϑ \cdot H \cdot ( 1 + \frac{{ρ}^{2} ( x , y )}{{H}^{2}} )$$

In this formula, Δθ is the fixed, vertical, angular resolution of the sensor, e.g. Δθ=0.5°. Δρ depends on the ground position (x,y) and on the height of the sensor above ground. The resolution of the grid in azimuth (ie., the angular distance of two adjacent nodes) is simply
Δφ(x,y)=const=horizontal angular resolution of sensor e.g., Δφ=0.5°.
   Tᵢ(x,y) shall be constructed as a function which
(1) at position (x,y)=(xᵢ,yᵢ) assumes the value 1;
(2) in radial direction drops to 0 roughly at distance Δρᵢ=Δρ(xᵢ,yᵢ);
(3) following the azimuthal coordinate lines drops to 0 roughly at angular distance Δρ.

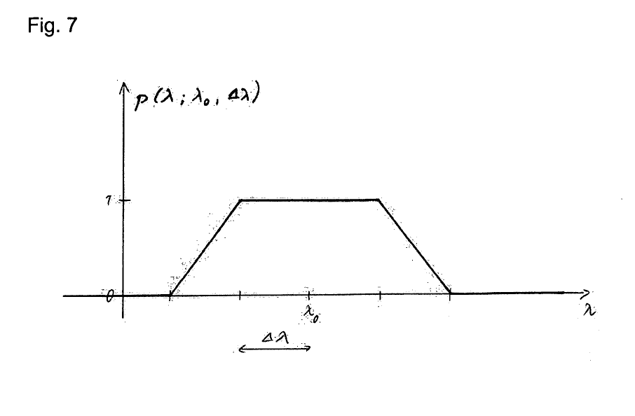

Let
p(λ;λ₀,Δλ)
quite generally denote a function of variable λ which for λ=λ₀ assumes the value 1 and for |λ−λ₀|>Δλ quickly drops to 0. (A piecewise linear example of such a function is shown in FIG. 7.) Using this function, Tᵢ(x,y) may be constructed as follows:
Tᵢ(x,y)=\overline{T}ᵢ(ρ,φ)=min{p(ρ;ρᵢ,Δρᵢ), p(φ;φᵢ,Δφ)}
ρᵢ,φᵢ here denote the polar coordinates of the Cartesian measurement coordinates xᵢ,yᵢ):

$${ρ}_{i} = \sqrt{{x}_{i}^{2} + {y}_{i}^{2}}$$

$${φ}_{i} = arctan ( \frac{{y}_{i}}{{x}_{i}} )$$

The Confidence Function altogether may now be constructed from the individual Confidence Functions for all measurement points as follows:

$$T ( x , y ) = \overline{T} ( ρ , φ ) = {max}_{i = 1 … 1} \{ {\overline{T}}_{i} ( ρ , φ ) \}$$

### EXAMPLE 2

### Detection of Ditches Using Matched Filtering

Overview

The method of “Matched Filter” in the “time domain” is applied to the detection of rectangular ditches of various directions and widths. As has been emphasized, work with real data has shown that applying the method to the edges of ditches is more robust than applying it to the ditches themselves. Thus strictly speaking, the issue is “ditch edge detection”.

“Matched Filtering” is the process of convolving the analysis filter—in the present case an oriented ditch template of defined width—with the signal under analysis—in the present case the normalized Ditch (Edge) Function W(x,y). (See the description above for procedure step Bridging of Ditches.) The convolution signal assumes values between −1 and 1 and indicates for any position (x,y) to which extent the analysis filter “fits” the signal (−1 for misfit, 1 for precise fit, 0 for level terrain).

Every new analysis filter produces its own convolution signal which is then compared to the other convolution signals. If a ditch is present in the analyzed signal at some position (x,y), the convolution signal with maximum amplitude will indicate the true orientation and width of that ditch. Conversely, if this maximal signal exceeds a certain threshold, it is assumed that at this position, there exists a ditch with the corresponding orientation and width.

Mathematical Formulation

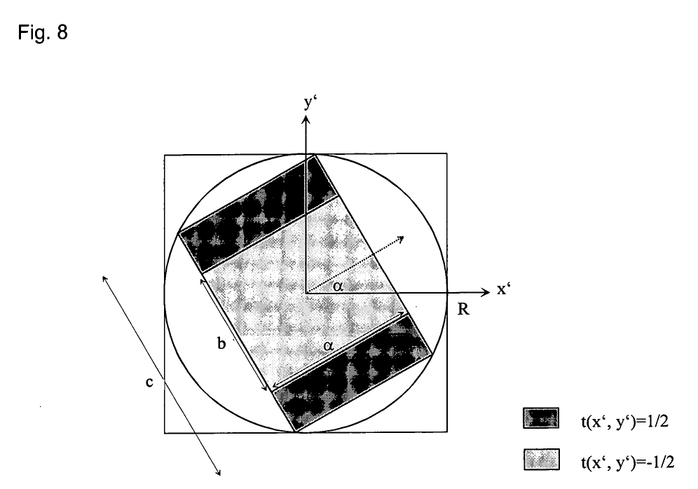

Let the analysis filters be denoted by
z=tₖ(x′,y′;b)
and defined as illustrated in FIG. 8: the lightly shaded area assumes the value −½, the dark one the value ½, and the remaining domain of definition the value 0. Each index k belongs to a different orientation. In a first implementation, it is sufficient to include k=0,1,2,3, corresponding to four elementary orientations:
0. length dimension of ditch parallel to x-axis (α=0 in FIG. 8)
1. length dimension of ditch parallel to main diagonal of x,y-coordinate system (α=45°)
2. length dimension of ditch parallel to y-axis (α=90°)
3. length dimension of ditch parallel to anti-diagonal of x,y-coordinate system (α=135°)

The parameter b defines the width of the ditch. As can be seen from FIG. 8, there is also a ditch length a. This parameter, however—in contrast to b and k—is not varied but assigned the same fixed value for all templates; it corresponds roughly to the width of the vehicle. Just like the remaining functions defining the MO, the analysis filters are defined on the nodes of a quadratic grid.

The convolution integral at position (x,y) is given by

$${F}_{k} ( x , y ; b ) = \frac{1}{{T}_{b}} \int \int {t}_{k} ( {x}^{′} , {y}^{′} ; b ) W ( x + {x}^{′} , y + {y}^{′} ) ⅆ {x}^{′} ⅆ {y}^{′}$$

and depends on the selected orientation and width. It contains the normalization factor
Tₕ=∫∫tₖ(x′, y′;b)²dx′dy′.

The integration extends over the quadratic domain of definition of the respective template. By choosing c=2b the templates are deliberately built such that they ignore ideally flat terrain:
∫∫tₖ(x′,y′;b)dx′dy′=0

Hence the value −1≦Fₖ(x,y;b)≦1 indicates how well the signal W(x,y) correlates with the template tₖ(x′, y′;b) at position (x,y).

The Ditch Orientation Function
kₘₐₓ(x,y)
and the Ditch Width Function
bₘₐₓ(x,y)
for every position (x,y) exhibit the k-index and b-width for which the convolution integral assumes the largest values. They can be defined implicitly as follows:

$${F}_{{k}_{max} ( x , y )} [ x , y ; {b}_{max} ( x , y ) ] = {max}_{b} \{ {F}_{0} ( x , y ; b ) , {F}_{1} ( x , y ; b ) , {F}_{2} ( x , y ; b ) , {F}_{3} ( x , y ; b ) \}$$

Ultimately the values of the function
F(x,y)=Fₖ_{ₘₐₓ}_{(x,y)}[x,y;bₘₐₓ(x,y)]
must be determined; more precisely, at all discrete nodes (xₖ,yₗ)
Fₖₗ=F(xₖ,yₗ)
If Fₖₗ exceeds a defined threshold u (e.g. u=0.5) at some node (xₖ,yₗ):
Fₖₗ>u
that node is assumed to be a ditch (edge) node, and the corresponding ditch edge width and orientation are given by
bₘₐₓ(xₖ,yₗ)
and
kₘₐₓ(xₖ,yₗ)
respectively.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

List of Acronyms

G Terrain Elevation Function
A Floor Function
T Confidence Function
Z Terrain Classification Function
MO Map of Obstacles
FE Finite Element
RIC Range Image Camera
RI Range Image
CS Coordinate System
DWT Discrete Wavelet Transform

1. A method of terrain analysis for off-road vehicles comprising:
generating a range image of the terrain in a scene that is scanned using a range-imaging sensor;
transforming sensor data of the scanned image into a three-dimensional surface which is composed of individual finite elements and which models the scene which has been scanned by the sensor; and
projecting the three-dimensional surface to yield a Terrain Elevation Function which is defined in a terrestrial coordinate system;
extending the Terrain Elevation Function continuously where it is undefined;
generating a Confidence Function for the Terrain Elevation Function defined in the same coordinate system as the Terrain Elevation Function, the Confidence Function representing a measure of confidence in the Terrain Elevation Function and depending on the distance of a value of the Terrain Elevation Function from a sensor measurement point;
generating a Floor Function by smoothing the Terrain Elevation Function;
generating a Terrain Classification Function by evaluating slope of the Terrain Elevation Function, comparing the Terrain Elevation Function with the Floor Function, and evaluating the Confidence Function; and
classifying the terrain with respect to its vehicular accessibility using the Terrain Classification Function.

2. The method according to claim 1, wherein a potential passage to bridge a ditch that is present in the terrain, is identified by:
filtering the Terrain Classification Function using templates for ditches of various widths and orientations, by Matched Filtering, to detect a course of a ditch or of its edge;
searching for potential routes along which to bridge the ditch, starting from points determined to lie on the edge of the ditch and proceeding orthogonally with respect to that edge, and validating a route using the Terrain Elevation Function, the Floor Function, and the Confidence Function.

3. The method in accordance with claim 2, wherein the continuous extension of the Terrain Elevation Function is accomplished by inserting into the scene a linear, two-dimensional plane whose optimizing parameters are computed from the Terrain Elevation Function in an available domain of definition via a Hough Transform.

4. The method in accordance with claim 3, wherein the smoothing of the Terrain Elevation Function for the purpose of computing the Floor Function is executed in two steps each consisting of a Discrete Wavelet Transform, and including an intermediate step where major obstacles are eliminated in preparation of the second step.

5. The method in accordance with claim 1, wherein the Finite Elements are triangular elements.
